(19) United States
(12) Patent Application Publication
(10) Pub. No.: US 2002/0134478 A1
(43) Pub. Date: Sep. 26, 2002

(54) Cord for a vehicle tyre and tyre provided with said cord

(76) Inventor: Omero Noferi, San Giovanni Valdarno (IT)

Correspondence Address: Finnegan, Henderson, Farabow,, Garrett & Dunner, L.L.P., 1300 I Street, N.W., Washington, DC, 20005-3315, US

(21) Appl. No.: 10/026,882

(22) Filed: Dec. 27, 2001

Related U.S. Application Data
(60) Provisional application No. 60/266,870, filed on Feb. 7, 2001.

(30) Foreign Application Priority Data
Dec. 28, 2000 (EP) 00830852.0

(51) Int. Cl. B31C 1/00

(52) U.S. Cl. 152/451; 156/169; 152/529; 152/534

(57) ABSTRACT

A cord for a tyre includes a strand of metallic core threads and at least two shells of metallic threads arranged around the core strand; the threads of the core strand and of the shells are wound helicoidally and have a “Lang Lay” type winding.

This application is based on European Patent Application No. 00830852.0 filed on Dec. 28, 2000 and U.S. Provisional Application No. 60/266,870 filed on Feb. 7, 2001, the content of which is incorporated hereinto by reference.

The present invention relates to a cord for a tyre for a vehicle and a tyre provided with said cord.

There are known vehicle tyres which have a carcass provided with a metallic reinforcement including cords, each cord consisting of a metallic core thread and two concentric shells of metallic threads arranged around the core thread. In these cords, the shell threads are wound helicoidally in the same direction (i.e., they have a so-called “Lang Lay” type winding), in a “S” (right-handed) or “Z” (left-handed) configuration.

The cords of the type described are very compact and their manufacturing costs are low. However, they have the disadvantage of having low resistance to fatigue and being subject to breaking and migration (displacement) of the core thread.

During the running of a vehicle, the cords of the tyre carcass are subjected to alternating bending stresses, particularly on the sidewalls, when the tyre enters and leaves the contact area with the ground (the footprint). In the case of a carcass having cords with core thread, these alternating bending stresses can easily lead to the breakage of the core thread.

Also in the case of a carcass having reinforcing cords with core thread, the core thread has a low degree of attachment to the innermost shell of threads. Therefore, during the production of the tyre, and also when it is in use, in other words during the running of the vehicle, the core thread may slip longitudinally within the radially innermost shell of threads, with consequent migration of the core thread beyond the ends of the cord.

In particular, during the production of a tyre, the migration of the core threads beyond the cords causes what is known as the brush effect. This consists in the emergence of portions of metallic core threads from the edges of the carcass ply or plies. These portions of projecting metallic threads are hazardous to tyre production workers, since they can cause wounds and injuries.

On the other hand, if the migration of the core threads occurs during the running of the vehicle, this can bring said threads to the surface of the tyre, thus forming a passage through which moisture and water can reach the metallic reinforcement and initiating a process of corrosion (rusting) which is propagated along the core threads within the cords, leading to the separation of the rubber from the metallic reinforcement and the breaking of the aforesaid cords.

There are also known tyres having carcass cords formed from a strand of metallic core threads and two concentric shells of metallic threads arranged around the core strand. In these cords, the metallic threads of the core strand are wound together helicoidally in a predetermined direction (“S”) and the metallic threads of the inner shell are wound helicoidally in the same direction (“S”) around said strand, while the metallic threads of the outer shell are wound helicoidally in the opposite direction (“Z”) around said inner shell.

The Applicant has found that when these cords with core strands are deformed, a phenomenon of rubbing (“fretting”) occurs among the threads, particularly between the threads of the core strand and the threads of the inner shell. The extent of this fretting is greater than that of the fretting between the threads of cords having core thread, and causes a rapid wear of the cords.

The object of the present invention is to eliminate the disadvantages of the known cords.

In a first aspect, the invention relates to a cord for a tyre including a strand of metallic core threads and at least two shells of metallic threads arranged around said strand, said threads of said strand and of said shells being wound helicoidally, characterized in that said threads of said strand and of said shells have a “Lang Lay” type winding.

Typically, the number of said threads of said strand is in the range from 2 to 5. In a preferred embodiment of the invention, the number of threads in said strand is three.

The number of threads of said radially inner shell is in the range from 5 to 9. In one embodiment, the number of said shell threads is 6.

The number of threads of said radially outer shell is in the range from 10 to 15. In one embodiment, the number of said shell threads is 12.

In one embodiment, said threads of said core strand and of said shells have a “S” winding.

In a further embodiment, said threads of said core strand and of said shells have a “Z” winding.

In a second aspect, the invention relates to a tyre for a motor vehicle, having a carcass including reinforcing cords, each of said cords including a strand of metallic core threads and at least two shells of metallic threads arranged around said core strand, said threads of said core strand and of said shells being wound helicoidally, characterized in that said threads of said core strand and of said shells have a “Lang Lay” type winding.

The cord according to the invention is particularly advantageous. This is because it has a greater tensile strength and lower bending rigidity than conventional cords with core thread, as well as it has a greater resistance to fretting than conventional cords provided with core strand.

Characteristics and advantages of the invention will now be illustrated with reference to one embodiment shown by way of example and without restrictive intent in the attached figures, in which:

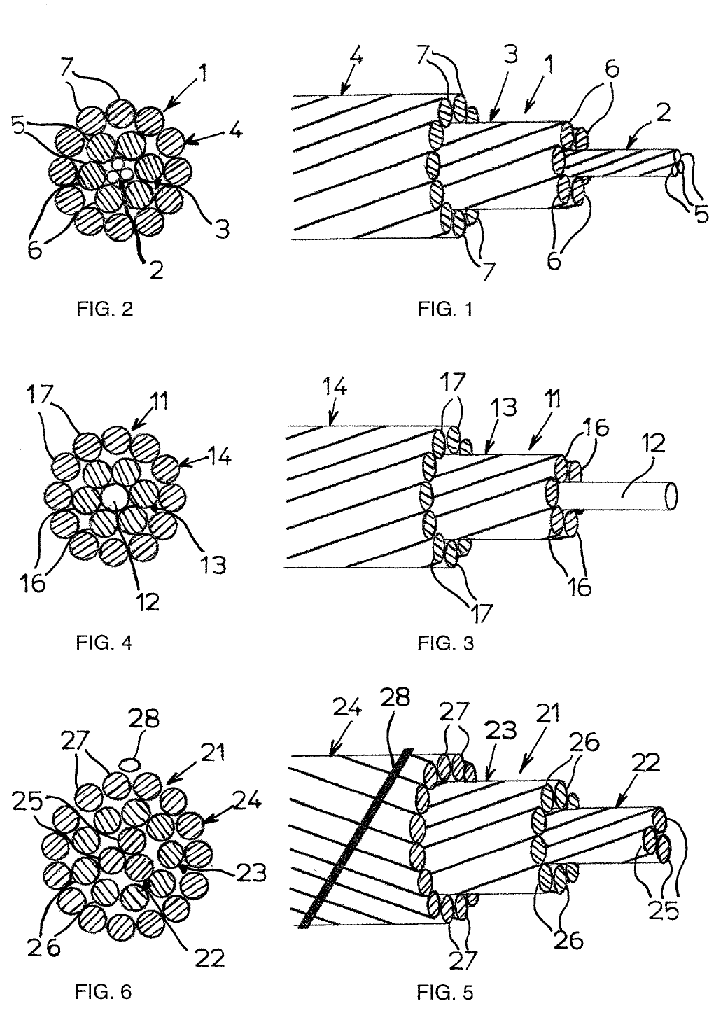

FIG. 1 is a partial perspective view of a cord for a tyre, made according to the invention;

FIG. 2 is a cross-sectional view of the cord of FIG. 1;

FIG. 3 is a partial perspective view of a conventional cord with core thread;

FIG. 4 is a cross-sectional view of the cord of FIG. 3;

FIG. 5 is a partial perspective view of a conventional cord with a core strand;

FIG. 6 is a cross-sectional view of the cord of FIG. 5;

FIG. 7 shows the scale for measuring the degree of wear of the threads used in the description of the present invention, based on the known Wallace method;

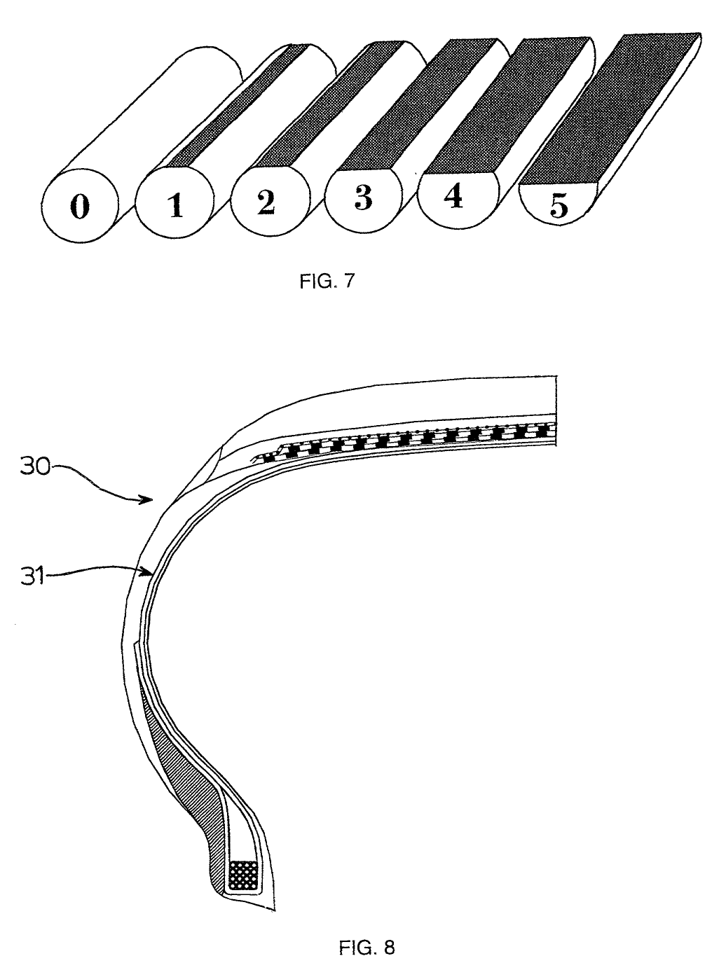

FIG. 8 is a partial view, in cross section, of a tyre having a carcass including cords made according to the invention;

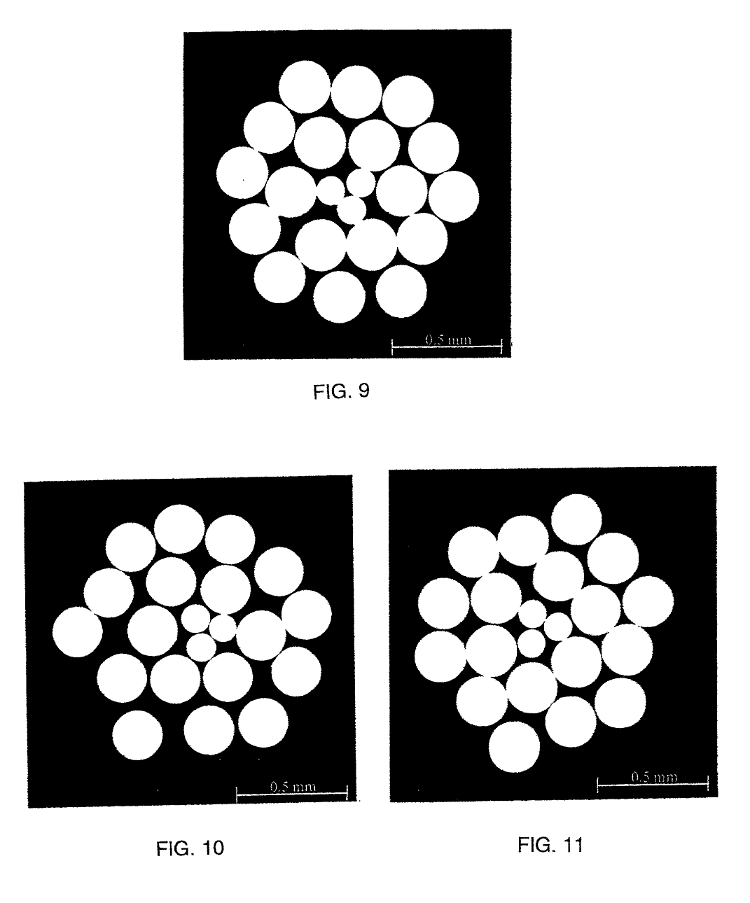

FIG. 9 is a photographic reproduction, enlarged 40 times, of the cross section of a cord according to the invention, in the initial condition, in other words before a fatigue test (alternate bending);

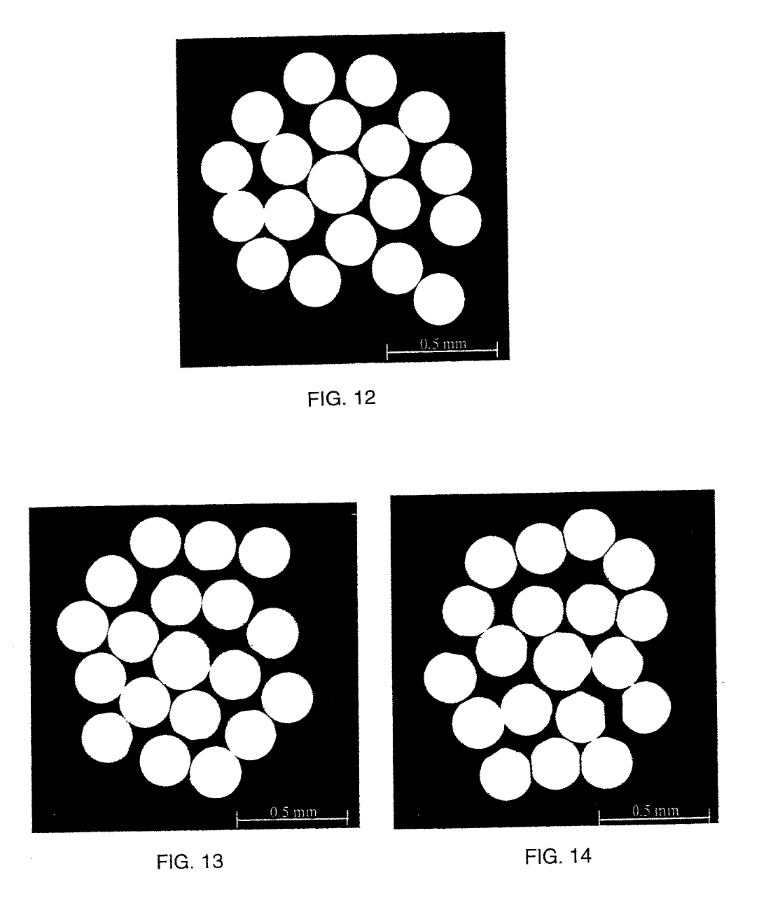

FIGS. 10 and 11 are photographic reproductions, enlarged 40 times, of two cross sections of the cord of FIG. 9, taken within the interval of one pitch, on completion of said fatigue test;

FIG. 12 is a photographic reproduction, enlarged 40 times, of the cross section of a conventional cord such as that of FIGS. 3 and 4, in the initial condition, in other words before a fatigue test (alternate bending);

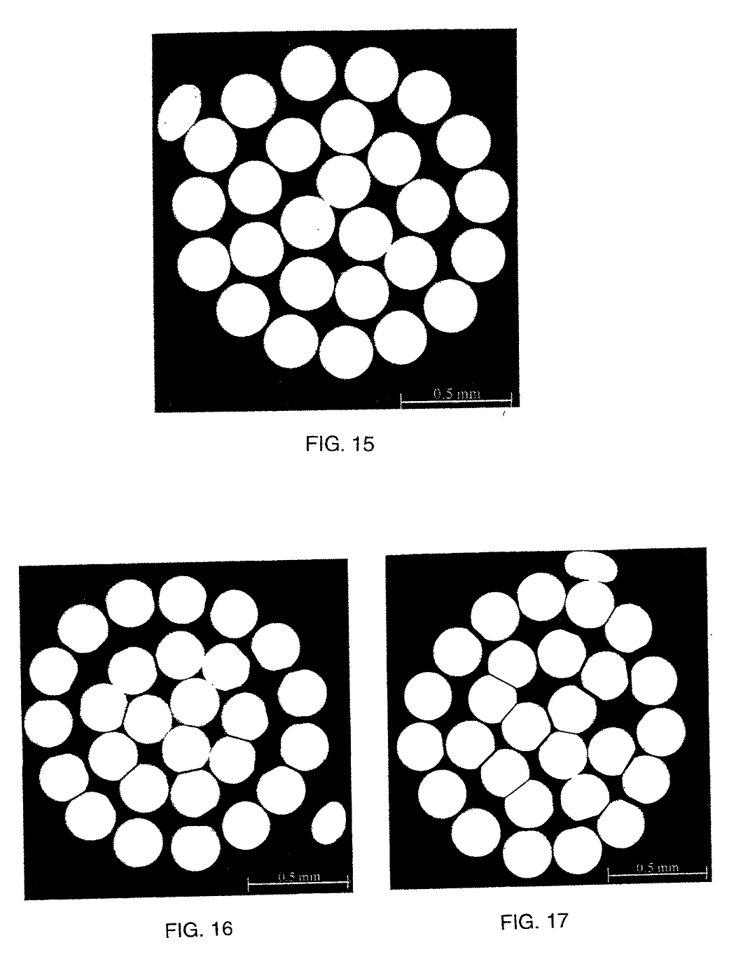

FIGS. 13 and 14 are photographic reproductions, enlarged 40 times, of two cross sections of the cord of FIG. 12, taken within the interval of one pitch, on completion of said fatigue test;

FIG. 15 is a photographic reproduction, enlarged 40 times, of the cross section of a conventional cord such as that of FIGS. 5 and 6, in the initial condition, in other words before a fatigue test (alternate bending);

FIGS. 16 and 17 are photographic reproductions, enlarged 40 times, of two cross sections of the cord of FIG. 15, taken within the interval of one pitch, on completion of said fatigue test.

FIGS. 1 and 2 show a preferred embodiment of a cord 1 for a tyre, made according to the invention. Said cord 1 comprises a core strand 2, an inner shell 3 and an outer shell 4. The core strand 2 consists of three metallic threads 5 wound together helicoidally with a “S” winding; the inner shell 3 consists of six metallic threads 6 wound helicoidally in a “S” winding around the threads of the core strand, and the outer shell 4 consists of twelve metallic threads 7 wound helicoidally in a “S” winding around the threads of the inner shell. As shown, the direction of winding of the threads of the core strand 2, and of the threads of both shells 3 and 4, is the same (“Lang Lay” type winding) in the cord 1 according to the invention. In this particular case, the winding of the threads is of the “S” type. In the above embodiment, the winding pitch is 14 mm.

The diameter of the aforesaid threads 5, 6 and 7 can vary from 0.10 mm to 0.40 mm, and does not have to be identical for all the threads of the cord.

Preferably, the diameter of the strand threads is smaller than that of the threads of the two concentric shells. Preferably, the diameter of the strand threads is in the range from 0.10 mm to 0.15 mm, while that of the shell threads is in the range from 0.20 mm to 0.30 mm, the difference between said values being at least 0.05 mm, and preferably at least 0.10 mm.

In all cases, the diameter of the threads and the number of threads in the strand and in the shells are interdependent, since they are related to the requirement of having compact cords, of small diameter, which at the same time are highly penetrable by the rubberizing material.

A cord in which the threads of the core strand 2 and the threads of both shells 3 and 4 have a “Z” winding has a performance similar to that of the corresponding cord with the “S” winding.

FIGS. 3 and 4 show a conventional cord 11 for a tyre, including a core thread 12, an inner shell 13 and an outer shell 14. The inner shell 13 consists of six metallic threads 16 wound helicoidally in a “S” winding around the core thread 12, and the outer shell 14 consists of twelve metallic threads 17 wound helicoidally in a “S” winding around the threads of the inner shell.

FIGS. 5 and 6 show a conventional cord 21 for a tyre, including a core strand 22, an inner shell 23 and an outer shell 24. The strand 22 consists of three metallic threads 25 wound together helicoidally in a “S” winding; the inner shell 23 consists of nine metallic threads 26 wound helicoidally in a “S” winding around the strand threads 22, and the outer shell 24 consists of fifteen metallic threads 27 wound helicoidally in a “Z” winding around the threads of the inner shell. A small thread (“wrap”) 28 is wound around the threads 27 of the outer shell 24. Therefore, in the cord 21 the threads 26 of the inner shell 23 and the threads 27 of the outer shell 24 are wound in opposite directions.

FIG. 8 shows a tyre 30 having a carcass 31 provided with reinforcing cords 1 according to the invention, as shown in FIGS. 1 and 2.

The Applicant has conducted a number of tests, comparing the performance of cords made according to the invention with that of conventional cords. The results of the tests are shown below.

In one set of tests (Tests 1 -4), three conventional cords provided with a core thread (of the type shown in FIGS. 3 and 4) and three cords provided with a core strand and made according to the invention (as shown in FIGS. 1 and 2) were compared with each other.

The structure of the cords used in said set of tests is shown in Table 1. The three conventional cords, identified by the numbers 1, 2 and 3, have a 1+6+12 configuration, while the three cords according to the invention, identified by the numbers 4,5 and 6, have a 3+6+12 configuration.

TABLE I

| Cord | Configuration | Pitch/Direction |
|---|---|---|
| 1 | 0.20 + 6 × 0.175 + 12 × 0.175 | 12.5 mm/Z |
| 2 | 0.25 + 6 × 0.22 + 12 × 0.22 | 16 mm/Z |
| 3 | 0.25 + 6 × 0.23 + 12 × 0.23 | 16 mm/Z |
| 4 | 3 × 0.10 + 6 × 0.175 + 12 × 0.175 | 12.5 mm/Z |
| 5 | 3 × 0.12 + 6 × 0.22 + 12 × 0.22 | 16 mm/Z |
| 6 | 3 × 0.12 + 6 × 0.23 + 12 × 0.23 | 16 mm/Z |

### Test No.1

### Pure bending

The test, consisting in winding a cord with a length of 1000 mm over a 100 mm diameter pulley, with no traction or torsion applied to the threads, and measuring the tensile and bending forces acting in the threads, was simulated in advance on a computer.

The test parameters were as follows:

| | |
|---|---|
| Dp = pulley diameter | 100 mm |
| Mt = torque applied to the ends of the cord | 0 N * mm |
| F = tension applied to the ends of the cord | 0 N |

The results of the test are shown in Table II below, where sigma 1 is the tension acting in the core thread of cords 1-3 or in the threads of the core strand in cords 4-6; sigma 2 and sigma 3 are, respectively, the tensions acting in the threads of the inner shell and in the threads of the outer shell of the aforesaid cords; Mb is the bending moment; and A* is the bending rigidity of the cords.

TABLE II

| | sigma 1 | sigma 2 | sigma 3 | Mb | A* |
|---|---|---|---|---|---|
| Cord | [MPa] | [MPa] | [MPa] | [N*mm] | [N*mm²] |
| 1 | 416 | 362 | 357 | 3.7 | 187.78 |
| 2 | 519 | 454 | 448 | 9.3 | 468.35 |
| 3 | 519 | 475 | 467 | 10.9 | 551.16 |
| 4 | 208 | 362 | 356 | 3.5 | 174.25 |
| 5 | 249 | 454 | 448 | 8.6 | 434.36 |
| 6 | 249 | 475 | 467 | 10.2 | 517.14 |

The data in Table II show that the tensions acting in the core strand (sigma 1) of cords 4-6 according to the invention were practically half of the tensions acting in the core thread (sigma 1) of the corresponding conventional cords 1-3, for an essentially identical bending moment. Additionally, the bending rigidity A* of cords 4-6 according to the invention was reduced by approximately 10% with respect to the bending rigidity of the corresponding conventional cords 1-3.

The tensions sigma 2 and sigma 3 remained essentially unchanged.

The experimental tests carried out subsequently in the laboratory confirmed the results obtained by the simulation. These tests were conducted on specimens of cord with a length of 1000 mm, fixed at both ends with a pair of clamps. At a point approximately halfway along its length, each specimen was fixed by winding on a 100 mm diameter pulley, which was subjected in a suitable way to cycles of vertical stress such that bending cycles were caused in the specimen.

Similar results were obtained when the test specimen was fixed to the pulley by contact only.

The above results therefore show that the cords according to the invention are capable of improving the resistance of the tyre to the cyclic bending stresses to which it is subjected when in use.

### Test 2

### Applied bending

The test consisted in subjecting the cord (having a length of 1000 mm) to an applied bending moment, of approximately 10 N mm, in the absence of traction and torsion, and measuring the tensile forces acting in the threads and the radius of curvature assumed by the cord. This radius of curvature corresponds to the diameter of the pulley which would cause a bending moment essentially equal to the applied bending moment to appear in the cord wound on this pulley under the same conditions. The test was simulated in advance on a computer.

The test parameters were as follows:

| | |
|---|---|
| Mb = bending moment applied to the cord | 10 N * mm |
| Mt = torque applied to the ends of the cord | 0 N * mm |
| F = tension applied to the ends of the cord | 0 N |

The results of the test are shown in Table IlI below.

TABLE III

| | sigma 1 | sigma 2 | sigma 3 | Dp | Mb |
|---|---|---|---|---|---|
| Cord | [MPa] | [MPa] | [MPa] | [mm] | [N*mm] |
| 1 | 1119 | 973 | 958 | 36.35 | 10.002 |
| 2 | 561 | 491 | 484 | 92.50 | 10.004 |
| 3 | 302 | 436 | 429 | 109.05 | 10.001 |
| 4 | 602 | 1048 | 1032 | 33.93 | 10.001 |
| 5 | 290 | 529 | 521 | 85.72 | 10.001 |
| 6 | 244 | 464 | 457 | 102.24 | 10.001 |

The test demonstrated that, for an essentially identical bending moment, cords 4-6 according to the invention could be wound on pulleys whose diameter Dp was smaller than that of pulleys on which the corresponding conventional cords 1-3 could be wound.

The experimental tests carried out subsequently in the laboratory confirmed the results obtained with the simulation. These tests were conducted with the use of a test apparatus similar to that described in test 1, with the difference that, in this case, a vertical load of 10 N was applied to the pulley mentioned above.

Therefore, according to the above data, cords 4-6 according to the invention were shown to be more flexible than the conventional cords 1-3.

### Test 3

### Pure tensile test

The test consisted in the application of a tension of 100 N to the cord while the torque and the bending moment at its ends were kept at zero. The test was simulated in advance on a computer.

In practice, the test was carried out by applying a tensile force to the cord and leaving it free to rotate about its own axis to dissipate the torque generated by said tension.

The test parameters were as follows:

| | |
|---|---|
| Mb = bending moment applied to the cord | 0 N * mm |
| Mt = torque applied to the cord | 0 N * mm |
| F = tension applied to one end of the cord | 100 N |

The results of the test are shown in Table IV below.

TABLE IV

| | sigma 1 | sigma 2 | sigma 3 | epsilon | beta |
|---|---|---|---|---|---|
| Cord | [MPa] | [MPa] | [MPa] | [mm] | [rad] |
| 1 | 523 | 499 | 365 | 0.002044 | −0.009506 |
| 2 | 326 | 313 | 230 | 0.001277 | −0.005971 |
| 3 | 302 | 294 | 215 | 0.001199 | −0.005528 |
| 4 | 513 | 551 | 396 | 0.002264 | −0.011 |
| 5 | 314 | 342 | 250 | 0.001393 | −0.006722 |
| 6 | 291 | 319 | 231 | 0.001298 | −0.006145 |

where “epsilon” and “beta” are, respectively, the axial deformation (tensile elongation) and the torsional deformation of the cord.

Also this test shows that the structure of cords 4-6 according to the invention is more effective than that of the corresponding conventional cords 1-3. The tensions in the core are reduced, although only by a small amount, while the tensions in the shell threads increase. The axial and torsional deformations increase, and this is an indication of increased flexibility of the cords according to the invention. Moreover, the tensions (sigma 1-3) are more uniform among the various layers of threads of the cords according to the invention than among those of the conventional ones.

The experimental tests carried out subsequently in the laboratory confirmed the results obtained with the simulation. These tests were conducted on specimens of cord, each having a length of 1000 mm and fixed by a clamp at one end. A tension of 100 N was applied to the free end of each specimen, said end being associated with a 100 mm diameter pulley.

### Test 4

### Combined tensile test

The test consisted in the application of a tension of 100 N to the cord while the bending moment at its ends was kept at zero and the cord was prevented from rotating about its own axis. The test was simulated in advance on a computer.

The experimental tests carried out subsequently in the laboratory confirmed the results obtained with the simulation.

The test parameters were as follows:

| | |
|---|---|
| Mb = bending moment applied to the cord | 0 N * mm |
| F = tension applied to the ends of the cord | 100 N |
| beta = angle of rotation between two axially | 0° |
| opposed sections of the cord | |

The results of the test are shown in Table V below.

TABLE V

| | sigma 1 | sigma 2 | sigma 3 | epsilon | Mt |
|---|---|---|---|---|---|
| Cord | [MPa] | [MPa] | [MPa] | [mm] | [N*mm] |
| 1 | 224 | 224 | 219 | 0.001068 | 4.524 |
| 2 | 142 | 142 | 139 | 0.000676 | 5.573 |
| 3 | 131 | 131 | 128 | 0.000623 | 5.957 |
| 4 | 229 | 228 | 223 | 0.00109 | 4.837 |
| 5 | 145 | 145 | 142 | 0.000691 | 5.825 |
| 6 | 134 | 133 | 130 | 0.000637 | 6.211 |

The test demonstrated that the cords 4-6 according to the invention withstood a torque greater than that withstood by the corresponding conventional cords 1-3. This means that they have a better resistance to the applied torsion.

The experimental tests carried out subsequently in the laboratory, using a test method similar to that of Test 3, confirmed the results obtained with the simulation.

To summarize, Tests 1-4 described above showed that the cords according to the invention had half of the tensions due to bending, as well as a lower bending rigidity (in other words a higher torque) with respect to the conventional cords which were considered.

### Test 5

### Wear due to rubbing (fretting)

With reference to Table I, the test was conducted by comparing the cord 5 (Invention), the conventional cord 2 (Comparative 1) and a conventional cord with a core strand (of the type illustrated in FIGS. 5 and 6) having the following structure: 3+9+15×0.22+0.15 (Comparative 2).

The specimens were formed by preparing strips of rubberized and vulcanized fabric comprising a predetermined number (generally from 3 to 5) of cords of the above types.

Each strip of fabric was subjected to a fatigue test consisting of a series of cyclical bendings (1500 kC in the case in question), caused by moving each fabric strip alternately in two directions around a roller of suitable dimensions (having a diameter of 32 mm in the case in question), to which a suitable pre-loading was applied (this pre-loading being chosen appropriately in relation to the dimensions of the reinforcing cords, and being 450 N in the case in question).

At the end of the test, the degree of wear of the individual threads was measured according to the scale of wear shown in FIG. 7. The degree of wear found in the individual threads of the cords is shown below in Table VI, in which each individual value indicates the degree of wear (measured according to the scale in FIG. 7) in one area of the thread, while the sum of a plurality of values indicates the total degree of wear in two or more areas of a single thread.

TABLE VI

| | | Invention | Comparative 1 | Comparative 2 |
|---|---|---|---|---|
| Cord | thread | 3 × 0.12 + 6 + 12 × 0.22 | 0.25 + 6 + 12 × 0.22 | 3 + 9 + 15 × 0.22 + 0.15 |
| Outer | 1 | 1 | 1 | 3 + 2 |
| Shell | 2 | 1 | 1 | 4 + 2 |
| | 3 | 1 | 1 | 3 + 2 |
| | 4 | 1 | 1 + 1 | 3 + 2 |
| | 5 | 1 + 1 | 1 + 1 | 2 + 2 |
| | 6 | 1 + 1 | 2 + 1 | 3 + 2 |
| | 7 | 1 + 1 | 1 + 1 | 3 + 3 |
| | 8 | 1 + 2 | 3 + 1 | 2 + 1 |
| | 9 | 1 | 1 | 3 + 2 |
| | 10 | 1 | 1 | 3 + 3 |
| | 11 | 1 | 1 | 3 + 2 |
| | 12 | 1 + 1 | 2 + 2 | 4 + 2 |
| | 13 | | | 3 + 2 |
| | 14 | | | 3 + 2 |
| | 15 | | | 2 + 2 |
| Inner | 1 | 1 + 1 | 1 + 1 | 3 + 3 |
| Shell | 2 | 1 | 1 + 1 | 3 + 1 |
| | 3 | 1 | 2 + 1 | 3 + 2 |
| | 4 | 1 | 1 + 1 | 2 + 2 |
| | 5 | 1 | 1 + 1 + 1 | 2 + 2 |
| | 6 | 2 + 1 | 2 + 1 + 2 | 3 + 2 |
| | 7 | | | 2 + 2 |
| | 8 | | | 3 + 2 |
| | 9 | | | 2 + 2 |
| Core | 1 | 1 + 1 | 1 + 1 + 2 + 1 | 1 + 1 + 1 |
| | 2 | 2 + 1 | | 1 + 2 |
| | 3 | 1 + 1 + 1 | | 1 + 2 + 1 |

For example, the value “2+1+2” relating to thread 6 of the inner shell of the “Comparative 1” cord indicates that said thread has three different areas of wear in the same cross section (said areas being identifiable in the figures as flattenings of the circular section of each thread), namely two areas with a degree of wear equal to 2 and one area with a degree of wear equal to 1.

The weight of the material removed (Fe) during the aforesaid wear tests was also measured. The values found in the cords are shown in Table VII below.

TABLE VII

| | | |
|---|---|---|
| Invention | Comparative 1 | Comparative 2 |

| | | | |
|---|---|---|---|
| Fe | 0.6 mg/kg | 1.3 mg/kg | 9.0 mg/kg |

As shown by the above table, at the end of the test it was found that the cord according to the invention had undergone a very low degree of wear due to fretting, this degree of wear being less than half of the wear of the Comparative 1 cord and about 15 times less than the wear of the Comparative 2 cord.

The initial and final states of the cords subjected to Test 5 are shown in FIGS. 9-17.

FIG. 9 is a photographic reproduction of a cross section of the cord according to the invention in the initial state. FIGS. 10 and 11 are photographic reproductions of two cross sections of the cord according to the invention in the final state, after 1500 kilocycles (kC), where the cross sections have been taken within the same pitch.

FIG. 12 is a photographic reproduction of a cross section of the Comparative 1 cord in the initial state. FIGS. 13 and 14 are photographic reproductions of two cross sections of the Comparative 1 cord in the final state, after 1500 kilocycles (kC), where the cross sections are close to each other, within the same pitch.

FIG. 15 is a photographic reproduction of a cross section of the Comparative 2 cord in the initial state. FIGS. 16 and 17 are photographic reproductions of two cross sections of the Comparative 2 cord in the final state, after 1500 kilocycles (kC), where the cross sections are close to each other, within the same pitch.

The comparison between the photographs of the cross sections of the same cord before and after the fretting test illustrates in a clearly visible way the amount of wear on the different threads of the cord, this wear being represented by the flattening of the circular section of each thread.

1. Cord comprising a strand of metallic core threads and at least two shells of metallic threads arranged around said core strand, said threads of said core strand and of said shells being wound helicoidally, characterized in that said threads of said core strand and of said shells have a “Lang Lay” type winding.

2. Cord according to claim 1, characterized in that the number of said threads of said core strand is in the range from 2 to 5.

3. Cord according to claim 1, characterized in that said threads of said core strand and of said shells have a “S” winding.

4. Cord according to claim 1, characterized in that said threads of said core strand and of said shells have a “Z” winding.

5. Tyre for a motor vehicle, having a carcass including cords, each of said cords including a strand of metallic core threads and at least two shells of metallic threads arranged around said core strand, said threads of said core strand and of said shells being wound helicoidally, characterized in that said threads of said core strand and of said shells have a “Lang Lay” type winding.

6. Tyre according to claim 3, characterized in that the number of said threads of said core strand is in the range from 2 to 5.

7. Tyre according to claim 3, characterized in that said threads of said core strand and of said shells have a “S” winding.

8. Tyre according to claim 3, characterized in that said threads of said core strand and of said shells have a “Z” winding.
